(19) United States
(12) Patent Application Publication
(10) Pub. No.: US 2002/0111077 A1
(43) Pub. Date: Aug. 15, 2002

(54) Universal splitter for xDSL modems

(76) Inventor: John A. Keenum, Keller, TX (US)

Correspondence Address: CORNING CABLE SYSTEMS LLC, P O BOX 489, HICKORY, NC, 28603, US

(21) Appl. No.: 09/782,640

(22) Filed: Feb. 13, 2001

(51) Int. Cl. H01R 24/00

(52) U.S. Cl. 439/676

(57) ABSTRACT

A universal xDSL splitter includes a data jack that is configured to be compatible with either of the wiring configurations of the xDSL modems presently in widespread use in the telecommunications industry. The data jack is wired to receive a conventional RJ-11 style plug that utilizes positions 3 and 4 of the plug and data jack to electrically connect the xDSL splitter to the xDSL modem. At the same time, the data jack is also wired to receive a conventional RJ-11 style plug that utilizes positions 2 and 5 of the plug and data jack to electrically connect the xDSL splitter to the xDSL modem. In a preferred embodiment, gold contacts are provided in each of positions 2, 3, 4, and 5 of the data jack. Positions 2 and 5 are electrically connected together and positions 3 and 4 are electrically connected together.

### BACKGROUND OF THE INVENTION

1. Field of the Invention

The invention relates to a universal splitter having a data jack for electrically connecting a data signal from an xDSL splitter to an xDSL modem. More particularly, the invention is a universal xDSL splitter having a data jack for use with either of the wiring configurations of the xDSL modems presently in use in the telecommunications industry.

2. Description of the Related Art

Digital Subscriber Line (DSL) technology is an interim solution for higher speed data transmission and access to a global computer network, such as the World Wide Web. As utilized herein, the generic designation “xDSL” refers to the different types of DSL technologies that are available, including but not limited to, High Data Rate Digital Subscriber Line (HDSL), Very High Speed Digital Subscriber Line (VDSL), Rate Adaptive Digital Subscriber Line (RADSL), and Asymmetric Digital Subscriber Line (ADSL). Regardless of the type of technology, xDSL permits lower frequency voice signals and higher frequency data signals to be carried over a single provider line. As a result, an xDSL signal splitter is required to separate the line signal into voice and data signals. The voice and data signals are then routed through modular voice and data jacks to complimentary voice and data plugs leading from the subscriber's voice and data communications equipment, respectively. For example, the voice signal may be split off from the line signal and routed through a voice jack to the RJ-11 plug of a telephone receiver, while the data signal is split off from the line signal and routed through a data jack to the xDSL modem of a personal computer.

Presently, there are two different wiring configurations for electrically connecting an xDSL modem to an xDSL signal splitter in widespread use in the telecommunications industry. Certain manufacturers of xDSL modems have adopted a wiring configuration that utilizes positions 3 and 4 of a conventional RJ-11 plug to connect to the data jack provided on a signal splitter. Other manufacturers have adopted a wiring configuration that utilizes positions 2 and 5 of the RJ-11 plug and data jack. As a result, a subscriber of an xDSL service provider must possess a signal splitter having a data jack that is properly wired to connect to the wiring configuration of the particular manufacturer's xDSL modem. In the event that the splitter does not have a data jack compatible with the RJ-11 plug of the xDSL modem, significant time and effort is expended and additional cost is incurred in acquiring and installing a splitter having a properly wired data jack. Similarly, a subscriber may be unable to install a new xDSL modem in the event that a permanently installed splitter has a data jack that is not configured to accept the wiring configuration of the RJ-11 plug from the new modem.

Accordingly, it is apparent there is a specific need for a universal xDSL splitter that is configured to be compatible with either of the wiring configurations of the xDSL modems presently in widespread use in the telecommunications industry.

It is further apparent there is a specific need for a data jack for an xDSL splitter that is capable of electrically connecting an xDSL splitter to an xDSL modem having either of the wiring configurations presently in widespread use in the telecommunications industry.

### BRIEF SUMMARY OF THE INVENTION

In accordance with the above objectives, and others, the present invention is an xDSL splitter having a data jack that is compatible with either of the wiring configurations of the xDSL modems that are presently in widespread use in the telecommunications industry. In particular, the data jack includes a housing defining a recess. A first pair of electrical contacts are disposed within the recess of the housing. The first pair of electrical contacts are positioned within the recess to establish a first pair of electrical connections with a corresponding pair of electrical contacts disposed on the mating plug of an xDSL modem having a first wiring configuration. The data jack further includes a second pair of electrical contacts disposed within the recess defined by the housing. The second pair of electrical contacts are positioned within the recess to establish a second pair of electrical connections with a corresponding pair of electrical contacts disposed on the mating plug of an xDSL modem having a second configuration. One of the first pair of electrical contacts and one of the second pair of electrical contacts are electrically connected. Similarly, the other of the first pair of electrical contacts and the other of the second pair of electrical contacts are electrically connected. Accordingly, the data jack establishes an electrical connection with an xDSL modem having either the first wiring configuration or the second wiring configuration.

In one aspect of the invention, the one of the first pair of electrical contacts and the one of the second pair of electrical contacts are electrically connected to the data ring terminal provided on an xDSL splitter. The one of the first pair of electrical contacts and the one of the second pair of electrical contacts are ring contacts, and thus, are positioned within the recess of the data jack to establish an electrical connection with the ring contact of the xDSL modem. The other of the first pair of electrical contacts and the other of the second pair of electrical contacts are electrically connected to the data tip terminal provided on the xDSL splitter. The other of the first pair of electrical contacts and the other of the second pair of electrical contacts are tip contacts, and thus, are positioned within the recess of the data jack to establish an electrical connection with the tip contact of the xDSL modem.

In a more particular aspect of the invention, the housing of the data jack further defines plurality of positions within the recess. Each of the first pair of electrical contacts and each of the second pair of electrical contacts is disposed in a respective one of the plurality of positions. Preferably, the data jack is a conventional RJ-14 style data jack and the plurality of positions comprises a first position, a second position, a third position, a fourth position, a fifth position, and a sixth position. The first pair of electrical contacts are disposed in the third position and the fourth position. The second pair of electrical contacts are disposed in the fifth position and the second position. Thus, the one of the first pair of electrical contacts is disposed in the third position and the one of the second pair of electrical contacts is disposed in the fifth position. Likewise, the other of the first pair of electrical contacts is disposed in the fourth position and the other of the second pair of electrical contacts is disposed in the second position. As a result, the ring and tip contacts of the first pair of electrical contacts are disposed in position 3 and position 4, respectively, of the RJ-14 style jack. Similarly, the ring and tip contacts of the second pair of electrical contacts are disposed in position 5 and position 2, respectively, of the RJ-14 style jack.

The RJ-14 style jack defines a cavity for receiving an RJ-11 style plug. The corresponding pair of electrical contacts having the first wiring configuration or the corresponding pair of electrical contacts having the second configuration are disposed on the RJ-11 style plug. In the first wiring configuration, the corresponding pair of electrical contacts are disposed in position 3 and position 4 of the RJ-11 style plug. In the second wiring configuration, the corresponding pair of electrical contacts are disposed in position 5 and position 2 of the RJ-11 style plug. Accordingly, the RJ-14 style jack establishes an electrical connection with the RJ-11 style plug having either the first wiring configuration or the second wiring configuration. Preferably, the first pair of electrical contacts and the second pair of electrical contacts disposed within the cavity of the RJ-14 style jack are gold wire contacts. Similarly, the corresponding pair of electrical contacts having the first configuration and the corresponding pair of electrical contacts having the second configuration disposed on the RJ-11 plug are also gold wire contacts.

### BRIEF DESCRIPTION OF THE DRAWINGS

One or more preferred embodiments of the invention will be described more fully below and illustrated in the accompanying drawings in which:

FIG. 1 is a schematic wiring diagram of a telecommunications circuit comprising an xDSL splitter having a data jack according to the present invention;

FIG. 2 is an elevation view of the front face of the data jack of FIG. 1;

FIG. 3 is an elevation view of the rear face of the data jack of FIG. 1;

FIG. 4 is a plan view of a preferred embodiment of a universal xDSL splitter according to the present invention positioned on the back plate of a wall mount; and

FIG. 5 is a rear perspective view of the universal xDSL splitter of FIG. 4.

### DETAILED DESCRIPTION OF THE PREFERRED EMBODIMENTS OF THE INVENTION

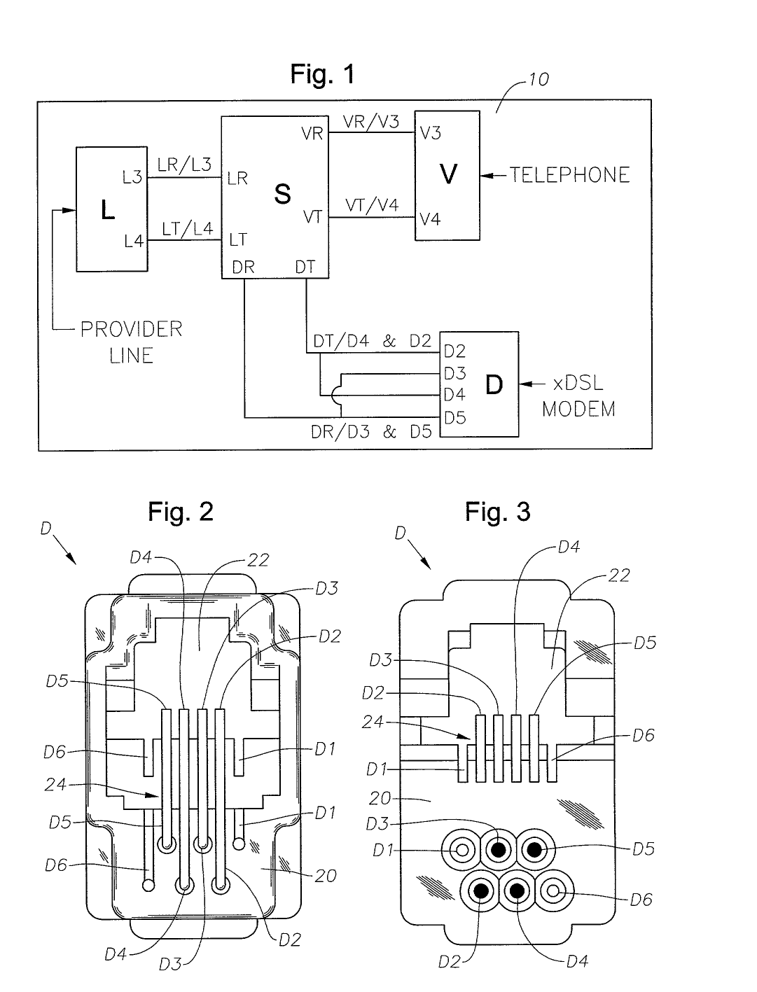

The aforementioned objects and advantages, and others, will be apparent from the following detailed description of preferred embodiments of the invention when considered in conjunction with the accompanying figures, which are intended to fully describe and to enable one of ordinary skill to make and use the invention without limiting the scope of the appended claims. In particular, a schematic wiring diagram of a telecommunications circuit, indicated generally at 10, is shown in FIG. 1. Telecommunications circuit 10 is a preferred embodiment of an xDSL splitter S having a data jack D according to the present invention. The splitter S further has a voice jack V and a line jack L, as will be described hereinafter. The splitter S is of the type commonly used in telecommunications network circuits to separate higher frequency data signals and lower frequency voice signals transmitted over a single service, or provider, line from, for example, a local telephone company. As is conventional, the line signal comprising the voice and data signals is transmitted via ring and tip wires over the provider line between a central office or distribution location and the splitter S located at a home or commercial building.

As is well known, the ring and tip wires of the provider line may be a twisted pair cable that are connected directly to screw terminals inside the splitter S. As shown and described herein, the ring and tip wires of the provider line are electrically connected to the ring and tip contacts of the line jack L, respectively. The line jack L is preferably an Rj-11 style jack and the provider line is configured to terminate in a complimentary RJ-11 style plug that is received within the line jack L. As is conventional, the ring wire of the provider line is electrically connected to a contact located in position 3 of the line jack L and the tip wire of the provider line is electrically connected to a contact located in position 4 of the line jack L. The contact located in position 3 of the line jack is referred to herein as the ring contact of the line jack L3 and the contact located in position 4 is referred to herein as the tip contact of the line jack L4. Although this wiring configuration is considered “standard” for an RJ-11 plug, the invention is not so limited and the positions of the wires may be reversed or different positions may be used without departing from the invention or diminishing the intended scope of the appended claims. The ring contact of the line jack L3 is electrically connected to the ring terminal for the line signal LR provided on the splitter S. Similarly, the tip contact of the line jack L4 is electrically connected to the tip terminal for the line signal LT provided on the splitter S. The electrical connection between the ring contact of the line jack L3 and the ring terminal for the line signal LR is designated as LR/L3 in FIG. 1. Similarly, the electrical connection between the tip contact of the line jack L4 and the tip terminal for the line signal LT is designated LT/L3 in FIG. 1.

As previously mentioned, the splitter S separates the provider line signal into a voice signal and a data signal. The design, construction and function of the splitter S is well known and forms no part of the present invention. The voice signal separated from the line signal by the splitter S is transmitted through voice jack V to, for example, a conventional telephone receiver. A ring terminal for the voice signal VR provided on the splitter S is electrically connected to a contact located in position 3 of the voice jack V. The contact located in position 3 of the voice jack V is referred to herein as the ring contact of the voice jack V3. A tip terminal for the voice signal VT provided on the splitter S is electrically connected to a contact located in position 4 of the voice jack V. The contact located in position 4 of the voice jack V is referred to herein as the tip contact of the voice jack V4. The electrical connection between the ring terminal for the voice signal VR and the ring contact of the voice jack V3 is designated VR/V3 in FIG. 1. Similarly, the electrical connection between the tip terminal for the voice signal VT and the tip contact of the voice jack V4 is designated VT/V4 in FIG. 1. Preferably, the voice jack V is an RJ-11 style jack and the telephone receiver terminates in a complimentary RJ-11 style plug that is received within the voice jack V.

The data signal separated from the line signal by the splitter S is transmitted to, for example, an xDSL modem. A ring terminal for the data signal DR provided on the splitter S is electrically connected to contacts located in position 3 and position 5 of the data jack D. The contacts located in position 3 and position 5 of the data jack D are referred to herein as the ring contacts of the data jack D3 and D5, respectively. A tip terminal for the data signal DT provided on the splitter S is electrically connected to contacts located in position 4 and position 2 of the data jack D. The contacts located in position 4 and position 2 are referred to herein as the tip contacts of the data jack D4 and D2. The electrical connection between the ring terminal for the data signal DR and the ring contacts of the data jack D3 and D5 is designated DR/D3 & D5 in FIG. 1. Similarly, the electrical connection between the tip terminal for the data signal DT and the tip contacts of the data jack D4 and D2 is designated DT/D4 & D2 in FIG. 1. Preferably, the data jack D is an RJ-11 style jack and the xDSL modem terminates in a complimentary RJ-11 style plug that is received within the data jack D.

The data jack D of the splitter S is shown in greater detail in FIG. 2 and FIG. 3. The data jack D comprises a housing, indicated generally at 20. As shown in FIG. 2, housing 20 defines a cavity 22 formed in the front face of the data jack D for receiving a complimentary data plug (not shown) from an xDSL modem. As previously mentioned, the data plug is preferably an RJ-11 style plug having a pair of thin, gold wire contacts to electrically connect the xDSL modem to a corresponding pair of contacts disposed within the cavity 22 of the data jack D. Presently, there are two different wiring configurations for the xDSL modems that are in widespread use in the teleconmmunications industry. In particular, certain xDSL modems include an RJ-11 style plug that is configured with the ring and tip contacts located in position 3 and position 4, respectively, of the plug. Other xDSL modems include an RJ-11 style plug that is configured with the ring and tip contacts located in position 5 and position 2, respectively, of the plug. As will be described in greater detail, data jack D has a plurality of contacts disposed within the cavity 22 defined by the housing 20. The plurality of contacts permit the data jack D to electrically connect the splitter S to an xDSL modem having a data plug configured with ring and tip contacts in position 3 and position 4, respectively, or with ring and tip contacts disposed in position 5 and position 2, respectively.

Specifically, data jack D is configured with four contacts, indicated generally at 24. The contacts 24 are disposed in position 2, position 3, position 4, and position 5 of the data jack D. Contacts 24 are arranged into two pairs of ring and tip contacts. One pair is defined by the ring and tip contacts disposed in position 3 and position 4 of data jack D. The contacts disposed in position 3 and position 4 are referred to herein as ring and tip contacts D3 and D4, respectively. The other pair is defined by ring and tip contacts disposed in position 5 and position 2 of data jack D. The contacts disposed in position 5 and position 2 are referred to herein as ring and tip contacts D5 and D2, respectively. Ring and tip contacts D3 and D4 are available to electrically connect the splitter S with an xDSL modem having a data plug configured with ring and tip contacts disposed in position 3 and position 4, respectively. Similarly, ring and tip contacts D5 and D2 are available to electrically connect the splitter S with an xDSL modem having a data plug configured with ring and tip contacts disposed in position 5 and position 2, respectively. As best illustrated in FIG. 1, the ring contacts of the data jack D3 and D5 are in electrical communication with one another. Similarly, the tip contacts of the data jack D4 and D2 are in electrical communication with one another. Accordingly, data jack D is compatible with an xDSL modem having a data plug having either of the wiring configurations that are presently in widespread use in the telecommunications industry. Specifically, data jack D is compatible with an xDSL modem having a data plug configured with ring and tip contacts disposed in position 3 and position 4, respectively, or ring and tip contacts disposed in position 5 and position 2, respectively. As shown herein, position 1 of the data jack, referred to herein as D1, and position 6 of the data jack, referred to herein as D6, are not provided with contacts. However, positions D1 and D6 may be provided with contacts to permit the data jack D to receive a data plug configured with ring and tip contacts disposed in position 1 and position 6, respectively. In such instance, ring contacts D3, D5, and D1 are in electrical communication with one another and tip contacts D4, D2, and D6 are in electrical communication with one another.

As shown in FIG. 3, the contacts D2, D3, D4, and D5 extend from the front face of the data jack D adjacent the data plug of the xDSL modem through openings formed in housing 20 to the rear face of the data jack D adjacent the splitter S. Alternatively, however, ring contacts D3 and D5 may be electrically connected on the front face of the data jack D (FIG. 2) and a single ring contact, either D3 or D5, may extend through one of the openings formed in housing 20 to the rear face of the data jack D (FIG. 3). Similarly, tip contacts D4 and D2 may be electrically connected on the front face of the data jack D and a single tip contact, either D4 or D2, may extend through one of the openings formed in housing 20 to the rear face of the data jack D. It is only necessary that the ring contacts of the data jack D3 and D5 remain in electrical communication with one another and that the tip contacts of the data jack D4 and D2 remain in electrical communication with one another. Data jack D may have any physical configuration, but preferably, data jack D is a conventional RJ-14 style jack defining a cavity having four thin, gold wire contacts disposed therein.

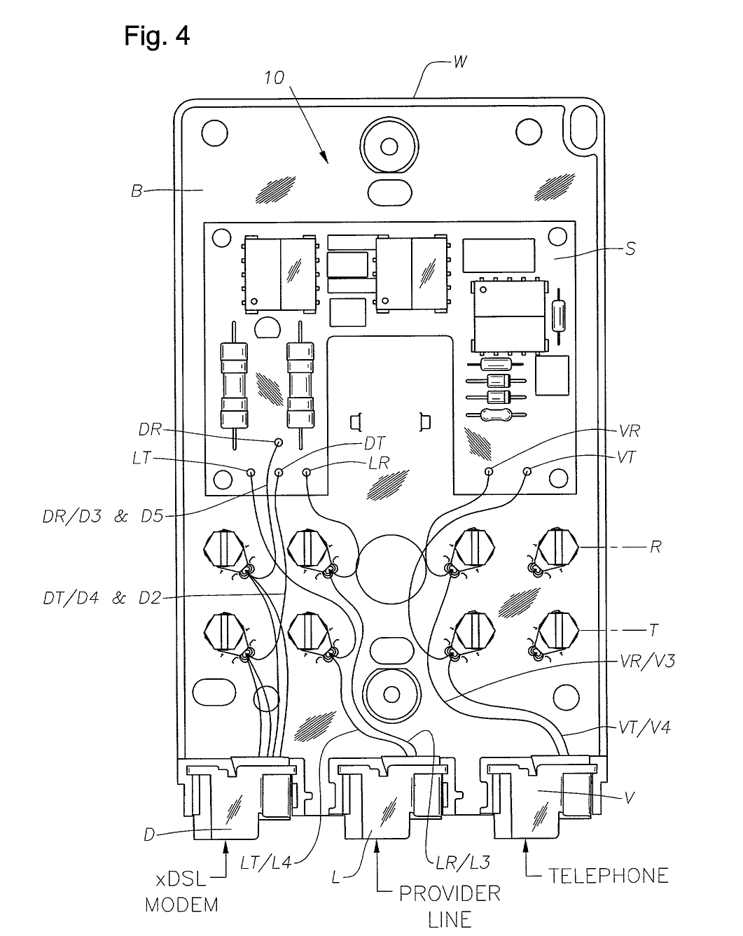

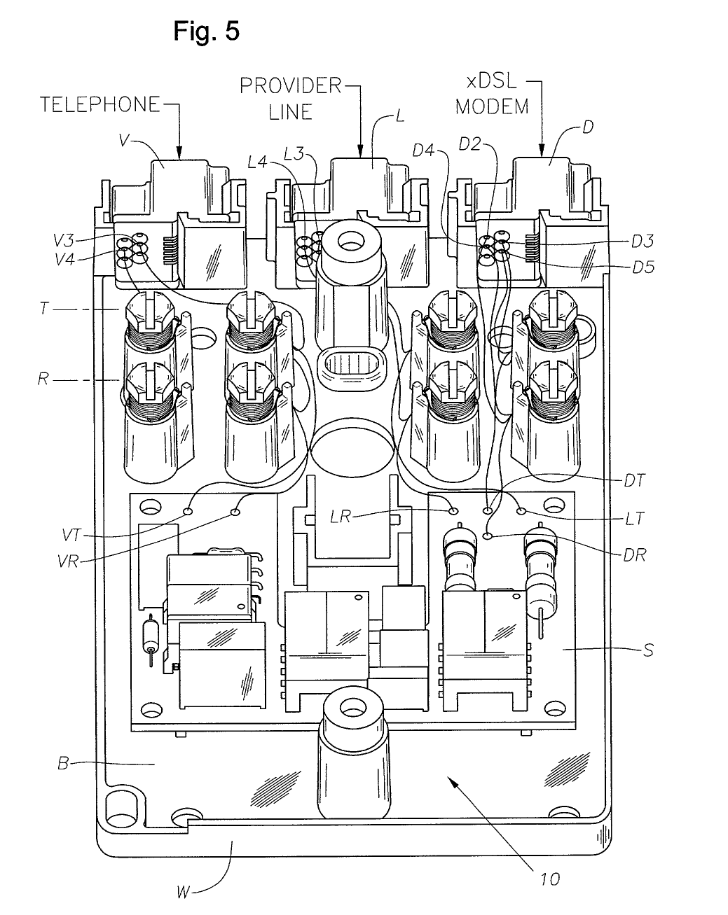

FIG. 4 illustrates a preferred embodiment of a telecommunications circuit 10 in the form of a universal xDSL splitter S according to the invention that is positioned on the back plate B of a conventional wall mount W. A rear perspective view of the universal xDSL splitter S is shown in FIG. 5. The splitter S has a line jack L, a voice jack V, and a data jack D, as previously described. As shown herein, the splitter S further comprises a plurality of ring terminals R and a plurality of tip terminals T affixed to the back plate B. The ring terminals R receive the lead wires for the electrical connections between the ring contacts L3, V3, D3, and D5 and the ring terminals LR, VR, and DR, respectively, provided on the splitter S. The ring terminals R establish the electrical connections LR/L3, VR/V3, and DR/D3 & DS previously described. Similarly, the tip terminals T receive the lead wires for the electrical connections between the tip contacts L4, V4, D4, and D2 and the tip terminals LT, VT, and DT, respectively, provided on the splitter S. The tip terminals T establish the electrical connections LT/L4, VT/V4, and DT/D4 & D2 previously described. Of course, the ring terminals R and the tip terminals T could be eliminated and the lead wires connected directly (i.e., “hard-wired”) to the ring terminals LR, VR, and DR provided on the splitter S and to the tip terminals LT, VT, and DT provided on the splitter S. Use of the ring terminals R and the tip terminals T, however, provides the ability to readily replace a damaged line jack L, voice jack V, data jack D, or splitter S without the need to first break and then re-solder the electrical connections on the ring terminals R and the tip terminals T of the splitter S.

The preferred embodiments of the invention illustrated and described herein provide a universal splitter having a data jack for electrically connecting a data signal from an xDSL splitter to an xDSL modem. More particularly, the preferred embodiments of the invention provide a universal xDSL splitter having a data jack for use with either of the wiring configurations of the xDSL modems presently in use in the telecommunications industry. Although the invention has been illustrated and described in various preferred embodiments, it is not intended to be so limited. Instead, it is intended that the invention be construed broadly in view of the foregoing written description and drawings to include any and all embodiments apparent to one of ordinary skill in the art.

That which is claimed is:

1. A data jack comprising:
a first pair of electrical contacts disposed on the data jack for establishing a first pair of electrical connections with a corresponding pair of electrical contacts having a first configuration; and
a second pair of electrical contacts disposed on the data jack for establishing a second pair of electrical connections with a corresponding pair of electrical contacts having a second configuration; and
wherein one of the first pair of electrical contacts and one of the second pair of electrical contacts are electrically connected and the other of the first pair of electrical contacts and the other of the second pair of electrical contacts are electrically connected.

2. A data jack according to claim 1
wherein the one of the first pair of electrical contacts and the one of the second pair of electrical contacts are electrically connected to the data ring terminal of a splitter; and
wherein the other of the first pair of electrical contacts and the other of the second pair of electrical contacts are electrically connected to the data tip terminal of the splitter.

3. A data jack according to claim 2
wherein the one of the first pair of electrical contacts and the one of the second pair of electrical contacts are ring contacts; and
wherein the other of the first pair of electrical contacts and the other of the second pair of electrical contacts are tip contacts.

4. A data jack according to claim 1
wherein the data jack comprises a housing defining a plurality of positions; and
wherein each of the first pair of electrical contacts and each of the second pair of electrical contacts is disposed in a respective one of the plurality of positions.

5. A data jack according to claim 4
wherein the plurality of positions comprises a first position, a second position, a third position, a fourth position, a fifth position, and a sixth position; and
wherein the first pair of electrical contacts are disposed in the third position and the fourth position; and
wherein the second pair of electrical contacts are disposed in the fifth position and the second position.

6. A data jack according to claim 4
wherein the plurality of positions comprises a first position, a second position, a third position, a fourth position, a fifth position, and a sixth position; and
wherein the one of the first pair of electrical contacts is disposed in the third position and the one of the second pair of electrical contacts is disposed in the fifth position; and
wherein the other of the first pair of electrical contacts is disposed in the fourth position and the other of the second pair of electrical contacts is disposed in the second position.

7. A data jack according to claim 4
wherein the first pair of electrical contacts are ring and tip contacts disposed in position 3 and position 4, respectively, of an RJ-14 style jack; and
wherein the second pair of electrical contacts are ring and tip contacts disposed in position 5 and position 2, respectively, of the RJ-14 style jack.

8. A data jack according to claim 7
wherein the RJ-14 style jack defines a cavity for receiving an RJ-11 style plug comprising one of the corresponding pair of electrical contacts having a first configuration and the corresponding pair of electrical contacts having a second configuration; and
wherein the first pair of electrical contacts and the second pair of electrical contacts are gold wire contacts disposed within the cavity of the RJ-14 style jack; and
wherein the corresponding pair of electrical contacts having a first configuration and the corresponding pair of electrical contacts having the second configuration are gold wire contacts disposed on the RJ-11 plug.

9. A data jack for an xDSL splitter comprising:
a housing defining a cavity;
a first pair of contacts disposed within the cavity for connection to a corresponding pair of contacts disposed having a first configuration and disposed on a mating plug of an xDSL modem; and
a second pair of contacts disposed within the cavity for connection to a corresponding pair of contacts having a second configuration and disposed on a mating plug of an xDSL modem.

10. A universal splitter comprising:
a data jack having a housing defining a cavity configured to receive a mating plug having a pair of electrical contacts, the data jack comprising:
a first pair of electrical contacts for establishing an electrical connection with the pair of electrical contacts of the mating plug when the pair of electrical contacts are disposed on the mating plug in a first configuration; and
a second pair of electrical contacts for establishing an electrical connection with the pair of electrical contacts of the mating plug when the pair of electrical contacts are disposed on the mating plug in a second configuration; and
wherein one of the first pair of electrical contacts and one of the second pair of electrical contacts are electrically connected and the other of the first pair of electrical contacts and the other of the second pair of electrical contacts are electrically connected so that the pair of electrical contacts of the mating plug establish an electrical connection with the first pair of electrical contacts and the second pair of electrical contacts in both the first configuration and the second configuration.

11. A universal splitter according to claim 10
wherein the splitter has a data ring terminal and a data tip terminal; and
wherein the one of the first pair of electrical contacts and the one of the second pair of electrical contacts are electrically connected to the data ring terminal of the splitter; and
wherein the other of the first pair of electrical contacts and the other of the second pair of electrical contacts are electrically connected to the data tip terminal of the splitter.

12. A universal splitter according to claim 11
wherein the one of the first pair of electrical contacts and the one of the second pair of electrical contacts are ring contacts; and
wherein the other of the first pair of electrical contacts and the other of the second pair of electrical contacts are tip contacts.

13. A universal splitter according to claim 10
wherein the housing of the data jack defines a plurality of positions; and
wherein each of the first pair of electrical contacts and each of the second pair of electrical contacts is disposed in a respective one of the plurality of positions.

14. A universal splitter according to claim 13
wherein the plurality of positions comprises a first position, a second position, a third position, a fourth position, a fifth position, and a sixth position; and
wherein the first pair of electrical contacts are disposed in the third position and the fourth position; and
wherein the second pair of electrical contacts are disposed in the fifth position and the second position.

15. A universal splitter according to claim 13
wherein the plurality of positions comprises a first position, a second position, a third position, a fourth position, a fifth position, and a sixth position; and
wherein the one of the first pair of electrical contacts is disposed in the third position and the one of the second pair of electrical contacts is disposed in the fifth position; and
wherein the other of the first pair of electrical contacts is disposed in the fourth position and the other of the second pair of electrical contacts is disposed in the second position.

16. A universal splitter according to claim 13
wherein the data jack is an RJ-14 style jack and the mating plug is an RJ-11 style plug; and
wherein the first pair of electrical contacts of the data jack are ring and tip contacts disposed in position 3 and position 4, respectively, of the RJ-14 style jack; and
wherein the second pair of electrical contacts of the date jack are ring and tip contacts disposed in position 5 and position 2, respectively, of the RJ-14 style jack; and
wherein the pair of electrical contacts of the mating plug are ring and tip contacts disposed in one of position 3 and position 4 respectively, or position 5 and position 2, respectively, of the RJ-11 style plug.

17. A data jack comprising:
a first electrical contact;
a second electrical contact;
a third electrical contact electrically connected to the first electrical contact; and
a fourth electrical contact electrically connected to the second electrical contact.

18. The data jack of claim 17
wherein the first electrical contact and the third electrical contact are ring contacts; and
wherein the second electrical contact and the fourth electrical contact are tip contacts.

19. The data jack of claim 18
wherein the first electrical contact is disposed in position 3 of an RJ-14 style jack and the third electrical contact is disposed in position 5 of the RJ-14 style jack; and
wherein the second electrical contact is disposed in position 4 of the RJ-14 style jack and the fourth electrical contact is disposed in position 2 of the RJ-14 style jack.

20. The data jack of claim 18
wherein the first electrical contact and the third electrical contact are electrically connected to the ring terminal for an xDSL modem provided on an xDSL splitter; and
wherein the second electrical contact and the fourth electrical contact are electrically connected to the tip terminal for the xDSL modem provided on the xDSL splitter.
